(19) United States
(12) Patent Application Publication
(10) Pub. No.: US 2016/0188804 A1
(43) Pub. Date: Jun. 30, 2016

(54) AMBULATORY MANAGER

(71) Applicant: CERNER INNOVATION, INC., Kansas City, KS (US)

(72) Inventors: Lura Elizabeth Lowery, Kansas City, MO (US); John David L. Nolen, Prairie Village, KS (US); Joshua I. Hayes, Kansas City, MO (US)

(21) Appl. No.: 14/587,218

(22) Filed: Dec. 31, 2014

(51) Int. Cl. G06F 19/00; G06Q 50/22

(52) U.S. Cl. CPC G06F 19/322; G06Q 50/22; G06F 19/328

(57) ABSTRACT

Methods, systems, and computer-readable media are provided for managing ambulatory orders. Electronic pending orders may be received in a central repository where they are held until requested by an authorized performing entity. The performing entity may be a laboratory. A performing entity is authorized using various criteria including patient information such as patient insurance, performing entity information such as services offered at the performing entity (e.g., tests performed at a laboratory). Each of the pending order and the completed order may be associated with identifiers that can be matched back to one another and associated with a patient's electronic health record (EHR) when completed.

### BACKGROUND

In the ambulatory setting, it is common practice to send a patient to an outpatient laboratory center for performance of an order (e.g., specimen collection). There are several factors that may influence which laboratory a patient presents themselves to such as, for example, insurance, convenience, affiliated providers, and the like. In most cases, a patient brings a paper requisition with them to their selected laboratory. The ordered test is performed and results are sent and matched back to the patient to be included in the patient's record (e.g., an electronic health record (EHR)).

Problems existing with this practice include, for example, an unknown selected location by a patient since it is not always known where a patient will choose to present themselves; missing or incomplete information on the physical requisition; difficulty matching results back to the initial order; being unable to match the results back to the initial order such that manual entry is required; and delayed results, errors, and low patient/clinician satisfaction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for managing ambulatory orders. Electronic orders, in an ambulatory setting, may be entered and held in a central repository until requested by an authorized performing entity. A performing entity, as used herein, refers generally to an entity capable of performing a pending order. Performing entities may be identified based on criteria including insurance information, costs, services provided by a particular performing entity, convenience, etc. Once a performing entity is identified as available, the order may be held until requested by one of the authorized performing entities. Identifiers may be provided in the request that correspond to the order.

### BRIEF DESCRIPTION OF THE DRAWINGS

Embodiments are described in detail below with reference to the attached drawings figures, wherein:

FIG. 1 is a block diagram of an exemplary computing system suitable to implement embodiments of the present invention;

FIG. 2 is a diagram of an exemplary system architecture suitable to implement embodiments of the present invention;

FIG. 3 depicts an exemplary graphical user interface for managing ambulatory orders in accordance with an embodiment of the present invention;

FIG. 4 is a flow diagram showing a method for managing ambulatory orders in accordance with an embodiment of the present invention; and

FIG. 5 is a flow diagram showing a method for managing ambulatory orders in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for managing ambulatory orders. Electronic orders, in an ambulatory setting, may be entered and held in a central repository until requested by an authorized performing entity. Performing entities may be identified based on criteria including insurance information, costs, services provided by a particular performing entity, convenience, etc. Once a performing entity is identified as authorized, the order may be held until requested by one of the authorized performing entities. Identifiers are provided in the request so that the request can be matched to the proposed order. Identifiers are also used to match the proposed order with a completed order.

A first aspect is directed to a computerized method, carried out by at least one server having one or more processors. The method includes, receiving an indication of a proposed order for a patient, wherein the proposed order is associated with patient information for the patient; comparing the patient information with a plurality of entities; identifying one or more entities that are available to complete the proposed order; and holding the proposed order until requested by the one or more entities available to complete the proposed order.

A second aspect is directed to a system for managing ambulatory orders. The system includes one or more processors and one or more computer storage media storing computer-useable instructions that, when used by the one or more processors, causes the one or more processors to: receive an indication of a proposed order for a patient, wherein the proposed order is associated with patient information for the patient; compare the patient information with a plurality of entities; identify one or more entities that are available to complete the proposed order; and hold the proposed order until requested by the one or more entities available to complete the proposed order.

A third aspect is directed to one or more computer storage media having computer-executable instructions embodied thereon that, when executed, facilitate a method of managing ambulatory orders. The claim recites, in part, receiving an indication that a proposed laboratory order for a patient has been input into the patient's electronic health record (EHR); receiving patient demographic information for the patient, wherein the patient demographic information includes insurance information for the patient; comparing the insurance information for the patient with a plurality of laboratory entities; identifying one or more laboratory entities that can complete the proposed laboratory order based on the comparison of the insurance information for the patient and a list of tests performed by the one or more laboratory entities; associating the proposed laboratory order with an order identifier; holding the proposed laboratory order in a central repository until a request is received for the proposed laboratory order from one of the one or more laboratory entities that can complete the proposed laboratory order; receiving a request from a first laboratory for the proposed laboratory order; determining whether the first laboratory is a laboratory of the one or more laboratory entities that can complete the proposed laboratory order; upon determining the first laboratory is a laboratory of the one or more laboratory entities that can complete the proposed laboratory order, providing the proposed laboratory order to the first laboratory.

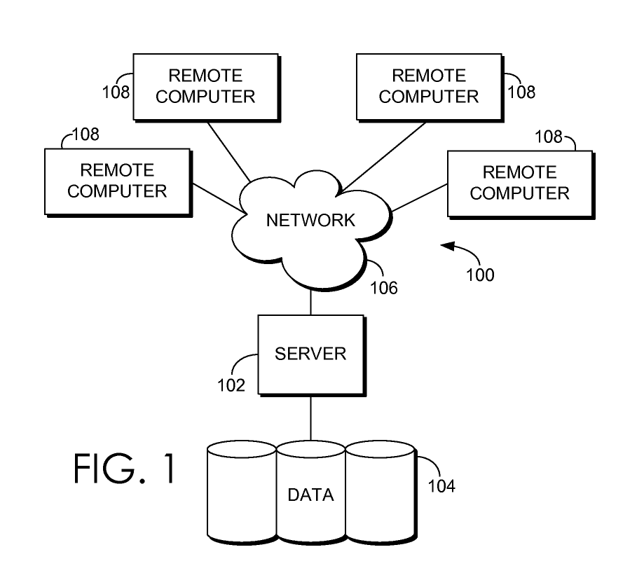

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer-readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and non-removable media implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provide storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health-care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

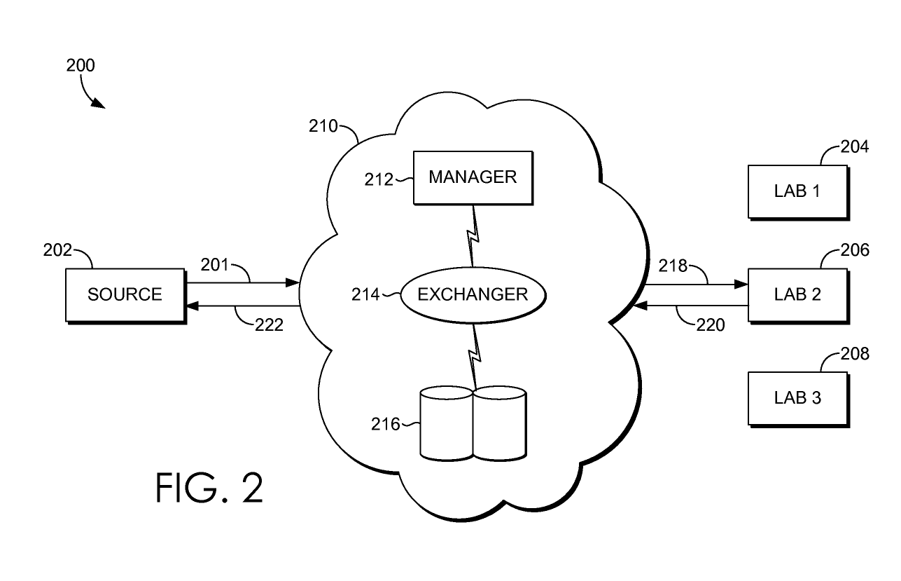

Turning now to FIG. 2, exemplary system architecture 200 suitable for implementing embodiments of the present invention is illustrated. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown the system 200 may include a source entity 202, a first lab entity 204, a second lab entity 206, a third lab entity 208, a network 210, an ambulatory manager 212, an exchanger 214, and a database 216. The components of the computing system 200 may communicate with each other via the network 210, which may include, without limitation, one or more local area networks (LANs) and/or wide area networks (WANs). Such networking environments are commonplace in offices, enterprise-wide computer networks, intranets and the Internet. It should be understood that any number of personal devices and serving engines may be employed in the computing system 200 within the scope of embodiments of the present invention. Each may comprise a single device/interface or multiple devices/interfaces cooperating in a distributed environment. For instance, the ambulatory manager 212 may comprise multiple devices and/or modules arranged in a distributed environment that collectively provide the functionality of the ambulatory manager 212.

The source entity 202 may be any entity associated with order entry. Exemplary source entities may include clinics, hospitals, laboratories, or any other healthcare facility. The source entity 202 may be configured for, among other things, communicating, receiving, and retrieving, etc., ambulatory orders and/or results. The source entity 202 may be associated with one or more patients' electronic health records (EHRs) (not shown).

Each of the first lab entity 204, the second lab entity 206, and the third lab entity 208 (which may collectively be referred to as performing entities throughout this disclosure) may be any entity associated with performance of an order and, in particular, performance of an ambulatory order. Exemplary performing entities may be laboratories, clinics, hospitals, and the like.

Each of the ambulatory manager 212, the exchanger 214, and the database 216 may facilitate communication between the source entity 202 and one or more of the performing entities. The communication may utilize a Health Level Seven International (HL7) framework or any industry standard appropriate to implement the present invention. Various communications occur between the source entity 202 and the one or more performing entities including, but not limited to, communication of pending orders, communication of completed orders, communication of patient information, communication of performing entity information, etc. Patient information may include patient demographic information, insurance information associated with the patient (e.g., insurance provider, coverage, etc.), and the like. Performing entity information may include services offered by a performing entity (e.g., tests performed), insurance accepted by the performing entity, costs related to a particular service, and the like. In particular, the exchanger 214 may directly communicate with any one of the other components illustrated in FIG. 2. In an embodiment, the exchanger 214 receives pending orders and completed orders from each of the source entity 202 and the performing entities (i.e., the first lab entity 204, the second lab entity 206, and the third lab entity 208).

The database 216 is configured to store pending orders, completed orders, patient information, results, educational information, and the like. The database 216 may be configured to communicate any necessary information to the manager 212 via the exchanger 214, for instance.

The manager 212 may be configured to receive, retrieve, communicate, or store pending orders, completed orders, or any information related thereto. The manager 212 may also be configured to analyze order information such that pending and completed orders are associated with one another when appropriate. The manager 212 may also be configured to hold any orders until an approved performing entity requests said orders. The manager 212 may be further configured to compare information such as patient information, performing entity information, and the like. Such comparisons will be discussed in further detail below.

In application, a user (e.g., a clinician) may input an electronic order. The order may be ambulatory in nature and may be input directly into a patient's EHR. Alternatively, the order may be input into any other order input service configured to communicate with one or more of the exchanger 214 or the manager 212. When inputting the order, the source entity 202 may request entity information from the manager 212 via communication 201. The entity information may include location of entities, insurance information affiliated with entities, cost information of entities, etc. The entities may choose which information to have published. For instance, if a particular entity chooses not to publish cost information associated with their services, it would not be submitted to the manager 212 and, thus, not returned to the source entity 202.

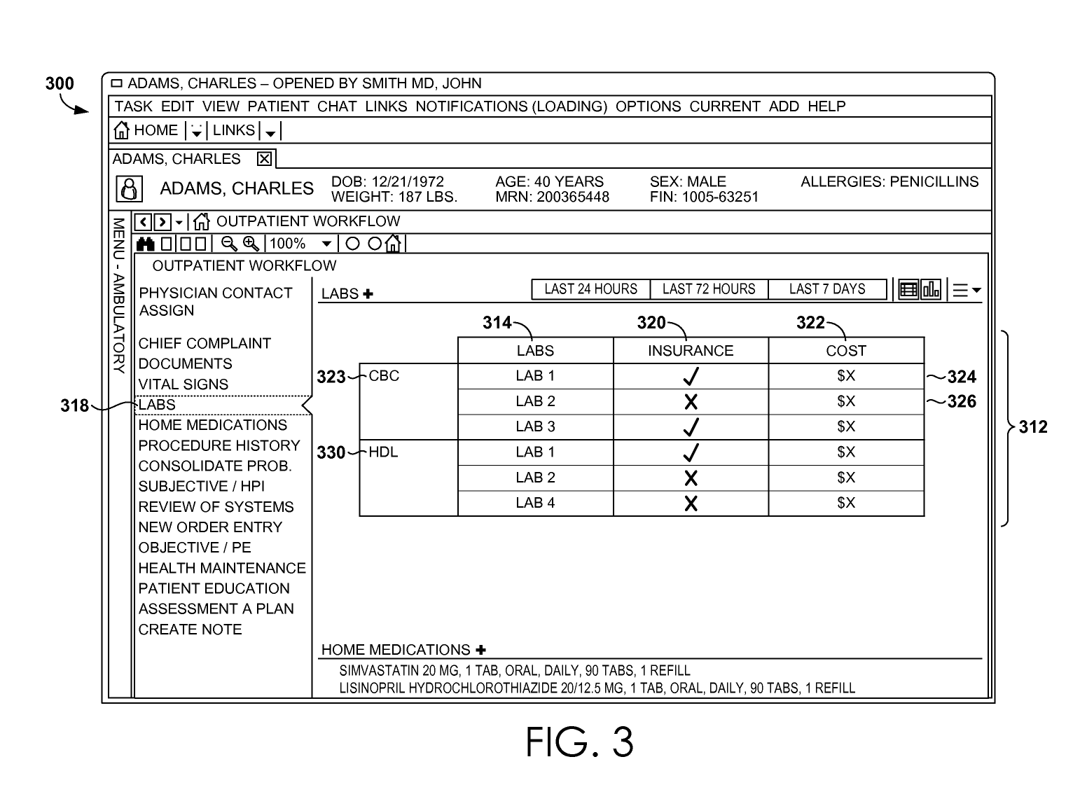

The manager 212 may provide the entity information via communication 222. Said entity information may be provided to a user via an entity information interface 300 provided in FIG. 3. In this particular example, labs are the subject order so a lab indicator 318 is selected to view the entity information. An entity information area 312 is provided that illustrates one or more orders (e.g., lab tests) such as test 323 and test 330. A list of entities may be provided in the performing entity list 314. Additionally, for each entity within the performing entity list 314 insurance and cost information may be provided as illustrated in insurance information column 320 and cost information column 322. As shown for LAB 1, illustrated in row 324, LAB 1 is indicated to accept insurance associated with the patient and a cost X is listed. The costs included in the cost information column 322 may be pre-insurance, post-insurance, or the like. Alternatively, multiple costs per one entity may be provided. In contrast, LAB 2, as illustrated in row 326, does not accept insurance associated with the patient. A cost may still be listed in this situation.

The information provided in the entity information interface 300 may be provided by the manager 212. In application, the manager 212 receives information for a particular entity and cross-references the entity information with patient information to determine specific entity details. For instance, LAB 1 may have communicated to the manager 212 that it accepts Insurances X, Y, and Z. The manager 212 stores that information. When a user requests entity information for a pending order, the manager 212 may identify, via patient information, that a particular insurance is associated with the patient such as, for example, Insurance Y and cross-reference the entity information to identify that LAB 1 does, in fact, accept the patient's insurance.

Once presented with the entity information, one or more entities may be selected by a user as approved entities. In other words, a clinician may limit which entities have access to the pending order once it is submitted to the manager 212. If no selections are made, all entities provided to the clinician by the manager may be indicated as approved entities. Alternatively, if no selections are made, only those entities that perform the desired service associated with the order or only those accepting the patient's insurance may be indicated as approved entities. User preferences may designate approved entities.

A pending order is then communicated to the manager 212 (via the exchanger 214). The pending order will not include a collection date or time since it is not complete. The proposed/pending order is associated with an order identifier. The order identifier may be any unique identifier known in the art. For example, the order identifier may be a unique set of letters, numbers, or a combination thereof. The pending order is then held in the manager 212 until requested by an approved entity.

A request for the pending order may be submitted by a performing entity such as the second lab entity 206 via communication 220, for example. A request for the pending order will be made when a patient presents themselves at the performing entity location. The patient may have a paper requisition with them including the order identifier such that the performing entity they choose may enter the information into the request. When a performing entity enters the order identifier into the request, the manager 212 may automatically determine the performing entity is an approved entity and communicate the order to the performing entity via communication 218.

When a performing entity does not enter the order identifier into the request (e.g., the patient presents at the location but forgets to bring a requisition with them) the manager may determine whether the performing entity is an approved entity. This determination may depend on a user selection of approved entities during order entry. Alternatively, in the situation where no selection was made, user preferences may be referenced. For instance, if no selection is made the system may default to only approving those entities that provide the services listed in the requisition.

Upon receiving the request, the pending order is communicated to the performing entity (i.e., the second lab entity 206). An admissions, discharges and transfers (ADT) message may also be communicated with the pending order. The ADT message may include patient information such that, in the event the performing entity does not have a record for the patient presenting with the pending order, the ADT will populate the performing entities system with the relevant information about the patient and create a new record that may be incorporated back into the patient's record at the source entity 202 (e.g., the EHR).

The second lab entity 206 then communicates the completed order back to the manager 212 via communication 220. The performing entity (i.e., the second lab entity 206) may associate the completed order with a completed order identifier. The completed order identifier may be associated with the results of the completed order separately or in addition to the order identifier originally associated with the pending order. The completed order identifier may be used to match the completed order back to the pending order and, ultimately, back to the patient's EHR.

Utilizing the present invention, it is not necessary to know definitively where a patient will present for performance of an order. Rather, holding the order in a central repository for transmission to an approved performing entity upon request allows clinicians to enter electronic orders without requiring a transmission directly to a performing entity. This, in turn, allows patients to decide for themselves where to go without also having to worry with paper requisitions. Thus, an electronic ambulatory manager allows electronic ambulatory orders to be held until requested by an approved entity.

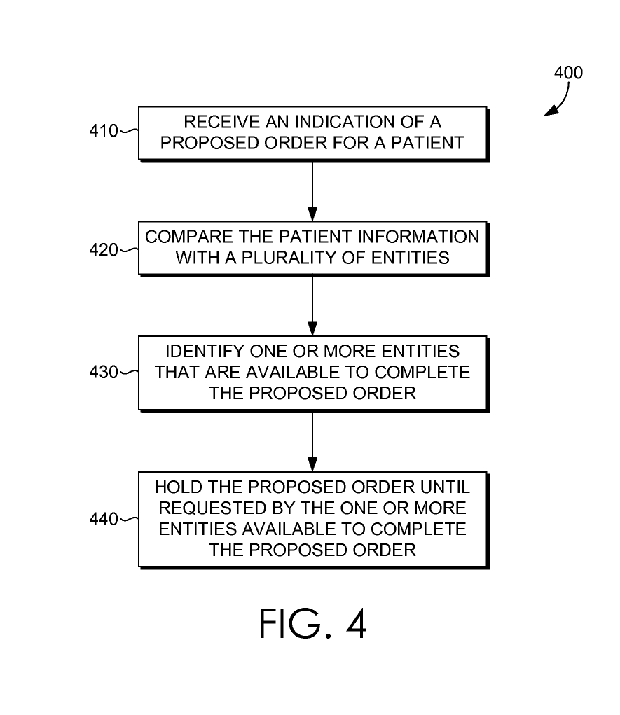

Referring now to FIG. 4, a flow diagram is provided illustrating a method 400 for managing ambulatory orders, in accordance with an embodiment of the present invention. Initially, at block 410 an indication of a proposed order for a patient is received. The indication may be that the order is entered into a patient's EHR or that the order is entered into the system. At block 420 the patient information is compared with a plurality of entities. At block 430 one or more entities that are available to complete the proposed order are identified. At block 440 the proposed order is held until requested by the one or more entities available to complete the proposed order.

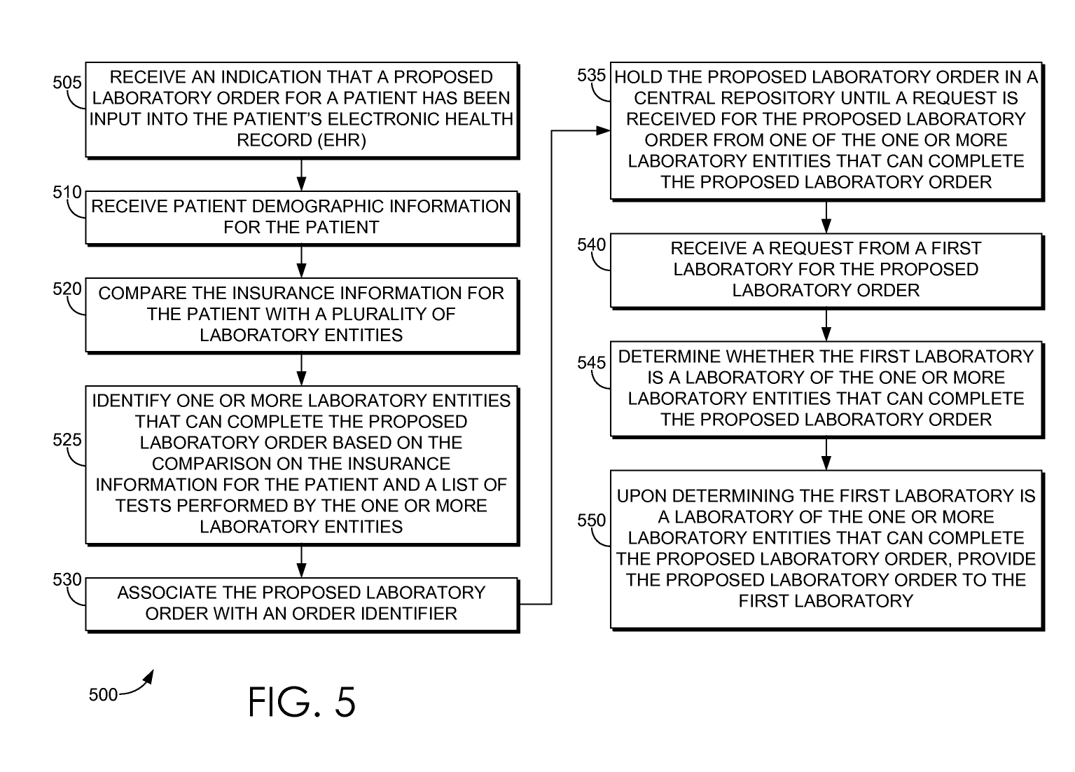

Turning to FIG. 5, a flow diagram is provided illustrating a method 500 for managing ambulatory orders, in accordance with an embodiment of the present invention. Initially, at block 505, an indication that a proposed laboratory order for a patient has been input into the patient's electronic health record (EHR) is received. At block 510, patient demographic information for the patient is received. The patient demographic information may include insurance information for the patient. At block 520, the insurance information for the patient is compared with a plurality of laboratory entities. At block 525, one or more laboratory entities that can complete the proposed laboratory order based on the comparison of the insurance information for the patient and a list of tests performed by the one or more laboratory entities is identified. At block 530, the proposed laboratory order is associated with an order identifier. At block 535, the proposed laboratory order is held in a central repository until a request is received for the proposed laboratory order from one of the one or more laboratory entities that can complete the proposed laboratory order. At block 540, a request from a first laboratory for the proposed laboratory order is received. At block 545, it is determined whether the first laboratory is a laboratory of the one or more laboratory entities that can complete the proposed laboratory order. At block 550, upon determining the first laboratory is a laboratory of the one or more laboratory entities that can complete the proposed laboratory order, the proposed laboratory order is provided to the first laboratory.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A computerized method, carried out by at least one server having one or more processors, the method comprising:
receiving an indication of a proposed order for a patient, wherein the proposed order is associated with patient information for the patient;
comparing the patient information with a plurality of entities;
identifying one or more entities that are available to complete the proposed order; and
holding the proposed order until requested by the one or more entities available to complete the proposed order.

2. The method of claim 1, wherein the one or more entities are available to complete the proposed order when the one or more entities are identified to accept insurance providers matching an insurance provider in the patient information.

3. The method of claim 1, wherein the one or more entities is a laboratory.

4. The method of claim 1, further comprising generating an admissions, discharges, and transfers (ADT) message to communicate with the proposed order.

5. The method of claim 1, wherein the patient information includes demographic information of the patient.

6. The method of claim 1, wherein the proposed order is initially input into a patient's electronic health record (EHR).

7. The method of claim 1, further comprising receiving a selection of the one or more entities indicating selected entities approved to access to the proposed order.

8. A system for managing ambulatory orders, the system comprising:
one or more processors; and
one or more computer storage media storing computer-useable instructions that, when used by the one or more processors, causes the one or more processors to:
receive an indication of a proposed order for a patient, wherein the proposed order is associated with patient information for the patient;
compare the patient information with a plurality of entities;
identify one or more entities that are available to complete the proposed order; and
hold the proposed order until requested by the one or more entities available to complete the proposed order.

9. The system of claim 8, wherein the one or more entities are available to complete the proposed order when the one or more entities are identified to accept insurance providers matching an insurance provider in the patient information.

10. The system of claim 8, wherein the one or more entities is a laboratory.

11. The system of claim 8, wherein the one or more processors generates an admissions, discharges, and transfers (ADT) message to communicate with the proposed order.

12. The system of claim 8, wherein the patient information includes demographic information of the patient.

13. The system of claim 8, wherein the proposed order is initially input into a patient's electronic health record (EHR).

14. The system of claim 8, wherein the one or more processors receives a selection of the one or more entities indicating selected entities approved to access to the proposed order.

15. The system of claim 8, wherein the one or more processors operates using a Health Level Seven International (HL7) framework.

16. One or more computer storage media having computer-executable instructions embodied thereon that, when executed, facilitate a method of managing ambulatory orders, the method comprising:
receiving an indication that a proposed laboratory order for a patient has been input into the patient's electronic health record (EHR);
receiving patient demographic information for the patient, wherein the patient demographic information includes insurance information for the patient;
comparing the insurance information for the patient with a plurality of laboratory entities;
identifying one or more laboratory entities that can complete the proposed laboratory order based on the comparison of the insurance information for the patient and a list of tests performed by the one or more laboratory entities;
associating the proposed laboratory order with an order identifier;
holding the proposed laboratory order in a central repository until a request is received for the proposed laboratory order from one of the one or more laboratory entities that can complete the proposed laboratory order;
receiving a request from a first laboratory for the proposed laboratory order;
determining whether the first laboratory is a laboratory of the one or more laboratory entities that can complete the proposed laboratory order; and
upon determining the first laboratory is a laboratory of the one or more laboratory entities that can complete the proposed laboratory order, providing the proposed laboratory order to the first laboratory.

17. The media of claim 16, wherein a Health Level Seven International (HL7) framework is utilized for communication of the proposed laboratory order.

18. The media of claim 16, further comprising receiving a completed order from the first laboratory, wherein the completed order is associated with a completed order identifier and the order identifier.

19. The method of claim 18, further comprising matching the completed order identifier to the order identifier of the proposed laboratory order and associating the proposed laboratory order with the completed order.

20. The media of claim 18, further comprising communicating the completed order to the patient's EHR.
